(19) United States
(12) Patent Application Publication
(10) Pub. No.: US 2017/0114962 A1
(43) Pub. Date: Apr. 27, 2017

(54) LED DEVICES FOR COLOR CHECKING OR MATCHING

(71) Applicant: Aixia Bian, Shanghai (CN)

(72) Inventor: Aixia Bian, Shanghai (CN)

(21) Appl. No.: 14/924,077

(22) Filed: Oct. 27, 2015

(51) Int. Cl. F21L 4/00; F21V 31/00; F21V 21/08; F21L 4/08; F21V 3/04

(52) U.S. Cl. CPC F21L 4/005; F21L 4/085; F21V 3/0409; F21V 21/08; F21V 31/00; F21Y 2101/02

(57) ABSTRACT

The present invention provides portable color checking or matching devices each comprising an LED light source with a color rendering index (CRI) of not less than 95%, a supporting unit securely housing the LED light source, a lens attached to the supporting unit and covering the LED light source, a power source contained in or attached to the supporting unit.

### CROSS-REFERENCE TO RELATED APPLICATION

This application claims priority to U.S. Application No. 62/152,290, filed on Apr. 24, 2015, the contents of which are incorporated herein by reference in their entireties.

### BACKGROUND OF THE INVENTION

The color rendering index (CRI), sometimes also called color rendition index, is a quantitative measure of the ability of a light source to reveal the color of an object faithfully in comparison with an ideal or natural light source. This parameter is regularly used in industry where color checking, recognition, or matching is critical, e.g., in the food processing industry or in painting room of an automotive body shop. For example, when foods are processed, a very subtle change in color of the foods may indicate a significant change (and generally deterioration) in quality. Therefore, it is essential in the food processing industry to have accurate recognition of the food color and to ensure that the quality of the foods does not deteriorate to the level of unhealthiness.

Currently, only incandescent or halogen light bulbs have been used in mobile color checking or color matching devices. However, the inherent light bulbs have several disadvantages including high consumption of power, high heat radiation, and low operating time for each circle of electricity recharge. As a result, it requires a wired connection to an external AC or DC power source, or frequent replacement or charging of internal electric power (e.g., batteries), and noise of fan for cooling down the high energy-consumption light. Therefore, the currently available and conventional lights for color checking or match bring much inconvenience and sometime even annoyance to workplaces that require such a device. An alternative to the current lighting device for color checking or matching is the natural light. However, due to the changing weather or indoor condition, natural light is not always available. As such, a better solution is needed to solve the long-existing issues discussed above.

### SUMMARY OF THE INVENTION

The present invention provides a highly efficient and portable light emitting diodes (LED) color checking or matching device with color rendering index (CRI) of generally not less than 95% (e.g., not less than 97%, 98%, 99%, or 99.5%). The device may be movable or removable (i.e., not permanently secured or fixed on an unmovable base subject, e.g., a wall or pole) and be used anywhere color recognition, checking or matching is required.

The portable color matching device of this invention includes an LED light source of color rendering index (CRI) of not less than 90%, a supporting device, a power source contained in the support device, and the LED light source is securely included in the supporting device. For instance, the supporting device can be a board or slab on which the LED light is placed centrally. The supporting unit can be temporarily affixed to a surface, e.g., via magnetic force on a metal surface, or provide a means for a user to conveniently place it (e.g., a hook for attaching the device to a pocket, or a flat bottom for placing on a surface).

The device can be powered by an external AC or DC source, or internal battery (such as Lithium (Li) ion battery or Li-Poly battery, or alkaline battery). As the LED light source consumes very little electricity, even internal battery (rechargeable or non-rechargeable) enables a long operation time of the device.

The device can be used anywhere and anytime as long as color checking or matching is required. For instance, in paint shops, food examination, fashion design, or art performing stages. The device can provide simulation of the sun light and is an alternative to natural sun light.

### BRIEF DESCRIPTION OF THE FIGURES

The invention may be better understood by referring to the following description in conjunction with the accompanying figures in which like reference numerals indicate elements in the device of this invention.

FIG. 1 shows an example of the devices of this invention.

FIG. 2 shows an example of the devices of this invention, which has a turnable supporting unit for creating an additional support.

FIG. 3 shows another example of the devices of this invention.

### DETAILED DESCRIPTION OF THE INVENTION

The present invention provides portable LED devices that are particularly suitable for color checking or/and matching purposes. In general, a portable device of this invention includes an LED light source with a color rendering index (CRI) of not less than 95%, a supporting unit securely housing the LED light source, a lens attached to the supporting unit and covering the LED light source, a power source contained in or attached to the supporting unit.

In some embodiments, the LED light source included in the devices of this invention can have an even higher CRI, e.g., not less than 97%, not less than 98%, or not less than 99%. As such, the LED light may closely resembles the natural light and provide a means and ability for accurately recognizing a color at issue for comparison with the target color.

In some other embodiments, the LED light source has a high watt/lumen efficiency, e.g., of not less than 30 lumen/watt, not less than 50 lumen/watt, not less than 75 lumen/watt, or not less than 100 lumen/watt.

In the device of this invention, the LED light source is mounted on the surface of a supporting unit and under the lens, thereby being enclosed within and protected by the supporting unit and lens. A supporting unit may take any form or shape that is necessary or suitable for the intended application environment. For example, the supporting can comprises a black curved board made of special non-reflecting plastics or resin that further includes a leg or a hook for the supporting unit to rest on a working surface (e.g., floor or ground) or to hang or clip on a belt. The supporting unit can take the shape of a stick, a column, a tube, a semi sphere, or a curved panel if that makes it easier to be held by hand. Optionally, the supporting unit may be foldable or turnable, for convenience in use, carring, or storage. The supporting unit can be made of various materials, e.g., a metal (such as aluminum) or a thermoset polymer (e.g., polyurethane or epoxy resin).

The device, particularly the portion where the LED light source is mounted and covered, is dustproof and/or waterproof.

A device of this invention can further include an indicator showing the charged level of a battery component of this device. Ideally, the battery should be recharged or replaced when the power level is under 10% or 5%.

In some other embodiments, a device of this invention can also include a removable power cable that can connect the device to an A/C power source as backup for a rechargeable battery. This would extend the length of the working cycle of the device. The connection between the cable and the device can be any of those familiar to a person skilled in the art. The power cable should be water, dust, or oil proof in order to maintain the full functionality of a device of this invention.

Still as further embodiments of this invention, a device of this invention can further includes a thermometer which measures the temperature of the LED light source and can cause the light source to be turned off when the temperature exceeds a threshold set by user. In addition, an optional fan can be included in the device to cool off the device when its temperature reaches a pre-determined level.

To keep the life of a device of this invention (particularly the LED), the device should include a lens that is not only resistant to hush weather (i.e., water or snow), but also high temperature. As illustrative examples, such a lens can be made of tempered or reinforced glasses, borosilicate glass, Grilamid TR 90, or polymethyl methacrylate.

Borosilicate glass is a type of glass with silica and boron trioxide as the main glass-forming constituents. It is known for having very low coefficients of thermal expansion (^{˜}3×10-6/° C. at 20° C.), making them resistant to thermal shock, more so than any other common glass. Such glass is less subject to thermal stress and is commonly used for the construction of reagent bottles. Many high-quality flashlights use borosilicate glass for the lens. This allows for a higher percentage of light transmittance through the lens compared to plastics and lower-quality glass. Several types of high-intensity discharge (HID) lamps, such as mercury vapor and metal halide lamps, use borosilicate glass as the outer envelope material. New lampworking techniques led to artistic applications such as contemporary glass marbles. The modern studio glass movement has responded to color. The availability of colors began to increase when companies such as Glass Alchemy introduced the Crayon Colors, which brought a whole new vivacity to the glass industry. Grilamid TR 90 is a transparent polyamide with good heat resistance and excellent fatigue behavior. Grilamid TR 90 also exhibits low moisture absorption and dimensional stability. Grilamid TR 90 was developed for use in filter bowls, eye glass frames, tooth brushes and optical fiber containing cables. It may also be considered for a variety of consumer and industrial applications in which chemical resistance, transparency and toughness are desired. Because Grilamid TR 90 contains no plasticizer and resists cosmetic chemicals and perspiration, it can enhance the design and performance of personal products such as sport and safety spectacle frames. Grilamid TR 90 is NSF Standard 61 Listed.

Polymethyl methacrylate (PMMA) is a transparent thermoplastic often used in sheet form as a lightweight or shatter-resistant alternative to soda-lime glass. The same material can be utilised as a casting resin; in inks and coatings, and also has other uses. Although not a type of familiar silica-based glass, the substance, like many thermoplastics, is often technically a type of glass (a non-crystalline vitreous substance) and historically has often been called acrylic glass. Chemically, it is the synthetic polymer of methyl methacrylate. PMMA is an economical alternative to polycarbonate (PC) when extreme strength is not necessary. Additionally, PMMA does not contain the potentially harmful bisphenol-A subunits found in polycarbonate. It is often preferred because of its moderate properties, easy handling and processing.

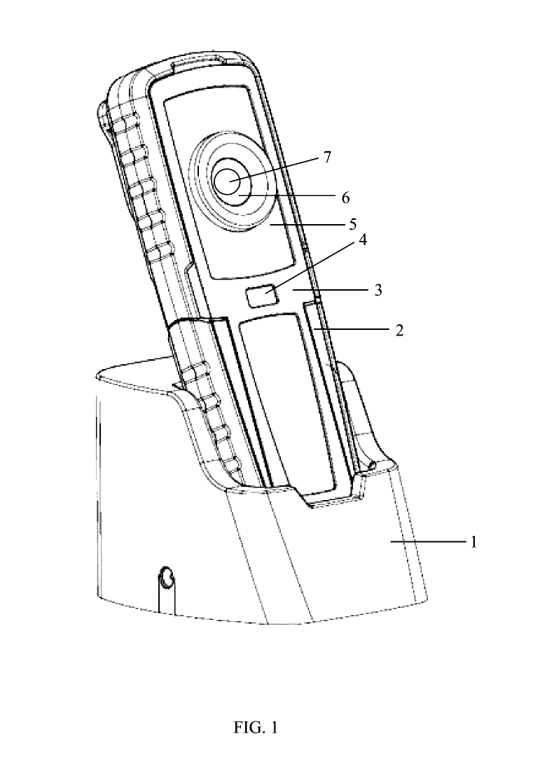

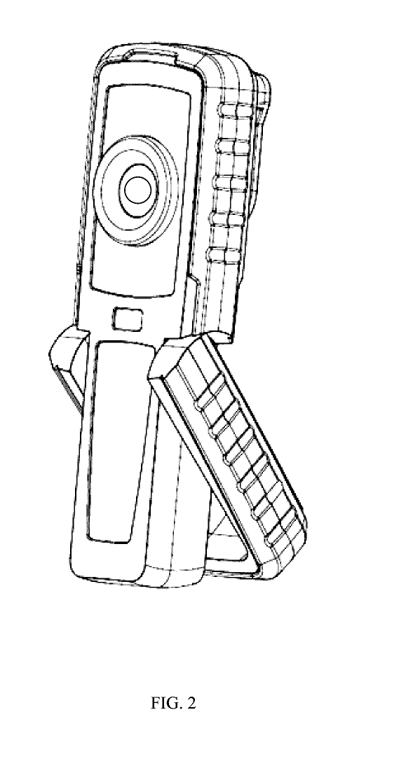

Shown in FIG. 1 herein is an example of the devices of this invention. It includes an optional base 1, a supporting unit consisting of two parts 2 and 3, a battery power level indicator 4, an optional cover 5, a lens 6 that is mounted atop of the LED light source 7. Parts 2 and 3 are so connected that the supporting unit becomes turnable to create a stand for itself as shown in FIG. 2.

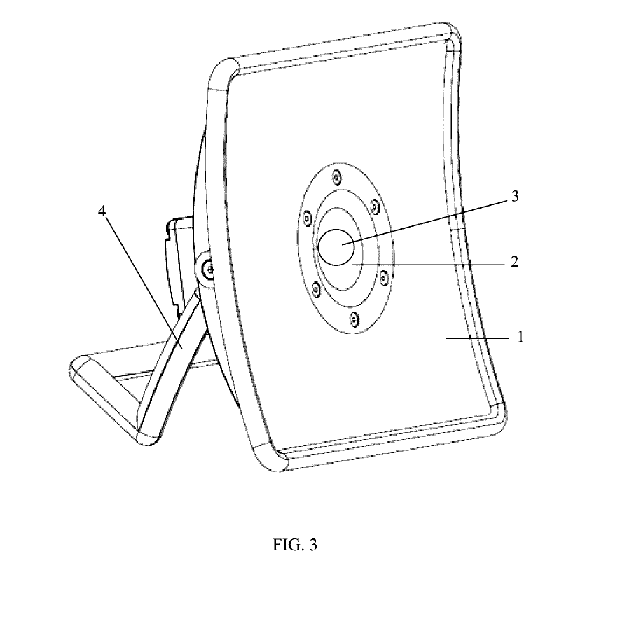

Shown in FIG. 3 is another example of the devices of this invention. It includes a supporting unit in the shape of a curve panel, an organic solvent resistant lens 2, and a high CRI COB LED light source 3, and an optional leg that leg that lends additional support to the device.

A device of this invention may be assembled by a technician and then used by shining the LED light to the color to be checked against the target color. The difference, if there is, between these two colors, is generally recognizable or discernable by a person skilled in the art, e.g., a professor painter, so that he/she can adjust the color at issue, if necessary, and bring it to match the color of target.

The advantages provided by the device of this invention include, but are not limited to, high mobility and portability, higher CRI, high energy efficiency, lower noise. These advantages have proved to be very significant.

While a general description and specific embodiments of the device of this invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

What is claimed is:

1. A portable device, comprising an LED light source with a color rendering index (CRI) of not less than 95%, a supporting unit securely housing the LED light source, a lens attached to the supporting unit and covering the LED light source, a power source contained in or attached to the supporting unit.

2. The device of claim 1, wherein the LED light source provides has a CRI of not less than 97%.

3. The device of claim 1, wherein the LED light source provides has a CRI of not less than 98%.

4. The device of claim 1, wherein the LED light source provides a color rendering index (CRI) of not less than 99%.

5. The device of claim 4, wherein the LED light source is a Chip-on-Board (COB) LED.

6. The device of claim 5, wherein the LED is a Surface-Mounted-Device LED.

7. The device of claim 6, wherein the LED is a lower power but high lumen LED.

8. The device of claim 1, wherein the LED has a luminous efficiency of at least 30 lumen/watt.

9. The device of claim 8, wherein the LED has a luminous efficiency of at least 50 lumen/watt.

10. The device of claim 9, wherein the LED has a luminous efficiency of at least 75 lumen/watt.

11. The device of claim 1, wherein the lens is made of a transparent and reinforced material that is resistant to organic solvent and high heat.

12. The device of claim 11, wherein the lens is made of or comprises reinforced glass, borosilicate glass, Grilamid TR 90, or polymethyl methacrylate.

13. The device of claim 1, wherein the power source is a rechargeable or non-rechargeable battery.

14. The device of claim 13, wherein the power source is a rechargeable lithium battery with a capacity of at least 1800 mAh.

15. The device of claim 14 wherein the power source is a rechargeable lithium battery with a capacity of at least 4000 mAh.
